(19) United States
(12) Patent Application Publication
(10) Pub. No.: US 2026/0177166 A1
(43) Pub. Date: Jun. 25, 2026

(54) SUPPORT AND STACKING DEVICES AND SYSTEMS RELATING THERETO

(71) Applicant: Miro Industries, Inc., Heber City, UT (US)

(72) Inventors: Jason Reed Haddock, Heber City, UT (US); Jarrett Welch, Heber City, UT (US); Richard R. Knight, Heber City, UT (US); Samuel Richard Robins, Heber City, UT (US); Chance Spensko, Heber City, UT (US); Kolten Post, Heber City, UT (US); John Post, Heber City, UT (US); Gary JR Kummer, Heber City, UT (US)

(21) Appl. No.: 19/430,085

(22) Filed: Dec. 22, 2025

Related U.S. Application Data
(60) Provisional application No. 63/737,465, filed on Dec. 20, 2024.

(51) Int. Cl. F16L 3/10; F16L 3/22

(52) U.S. Cl. CPC F16L 3/1016; F16L 3/222

(57) ABSTRACT

A support device includes a base member and a support member extending from the base member to a proximal end including a support receptacle. The support device also includes a coupling member extending along a stem portion to a head portion laterally spaced from the base member and the support member by the stem portion. A coupling receptacle is positioned opposite of the coupling member, and the coupling receptacle is structured to receive a component corresponding in structure to the coupling member. A system is also disclosed which includes two of these support devices which may be coupled to one another and, optionally, a stacking device which may be coupled to one of the support devices.

### FIELD

The present disclosure generally relates to a support and stacking devices. More particularly, but not exclusively, the present disclosure relates to a support device to which a variety of other components may be coupled, and which may be used for the support of objects on a rooftop or similar setting. The support device may be coupled to another support device and/or a stacking device to provide a system including one or more support devices and/or stacking devices.

### BACKGROUND

Unless otherwise indicated herein, the materials described herein are not prior art to the claims in the present application and are not admitted to be prior art by inclusion in this section.

Various objects, including HVAC ductwork, refrigeration lines, electric conduit and/or modular walkways, amongst others, may be positioned on the rooftop of a structure. Membrane materials may be used on the rooftop, and these materials may be damaged by the objects positioned on the rooftop. As such, direct positioning or fastening of these objects to the membrane may typically be avoided. Support devices may be used to space the objects from the rooftop and the objects may be secured to the support devices with one or more coupling components. Generally speaking, a support device designed to prevent rooftop damage and facilitate easy coupling of objects thereto, and which may be used in combination other same or similar devices to provide a system increasing space utilization, may be desired.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In one embodiment, a support device includes a base member, and a support member extending from the base member to a proximal end including a support receptacle. The support device further includes a coupling member including a stem portion and a head portion laterally spaced from the base member and the support member by the stem portion, and a coupling receptacle positioned opposite of the coupling member. The coupling receptacle is structured to receive a component corresponding in structure to the coupling member. For example, in one aspect the coupling receptacle includes a first portion configured complementary to the configuration of the stem portion and a second portion configured complementary to the configuration of the head portion.

In another embodiment, a stacking device includes a body extending between a proximal end and a distal end. The body includes a hollow interior and a central opening extending from and through the distal end toward the proximal end. The stacking device also includes a support surface defined by the proximal end of the body and positioned opposite of and spaced apart from the central opening. The stacking device further includes a number of guide members positioned in the hollow interior and extending distally toward the distal end of the body. Each of the guide members includes a proximal portion and a distal portion having a reduced size relative to the proximal portion.

In another embodiment, a system includes a plurality of stacking devices as described above, where the proximal end of a first stacking device is positionable in the hollow interior of a second stacking device in an arrangement where the distal end of each of the guide members of the second stacking device is positioned in a respective one of a first aperture and a second aperture of the first stacking device.

In yet another embodiment, a system includes a plurality of support devices as described above, where the coupling member of a first support device is positionable in the coupling receptacle of a second support device in an arrangement preventing lateral separation of the first support device and the second support device.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a support device;

FIG. 2 is an alternative perspective view of the support device of FIG. 1;

FIG. 3 is a top view of the support device of FIG. 1;

FIG. 4 is another alternative perspective view of the support device of FIG. 1;

FIG. 5 is a perspective view of a stacking device engageable with the support device of FIG. 1;

FIG. 6 is a side view of the stacking device of FIG. 5;

FIG. 7 is a bottom view of the stacking device of FIG. 5;

FIG. 8 is a section view of the stacking device of FIG. 5 taken along view line 8-8 in FIG. 6;

FIG. 9 is a perspective view of a system including a support device of FIG. 1 and a plurality of stacking devices of FIG. 5; and

FIG. 10 is a perspective view of a system including a plurality of support devices of FIG. 1 and a stacking device of FIG. 5.

### DETAILED DESCRIPTION

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

The present disclosure generally relates to support and stacking devices. More particularly, but not exclusively, the present disclosure relates to a support device to which a variety of other components may be coupled, and which may be used for the support of objects on a rooftop or similar setting. The support device may be coupled to another support device and/or a stacking device to provide a system including one or more support devices and/or stacking devices. It will be appreciated that embodiments disclosed herein may be employed in a variety of fields and/or operating environments where the functionality disclosed herein may be useful. Accordingly, the scope of the invention should not be construed to be limited to the exemplary implementations and operating environments disclosed herein.

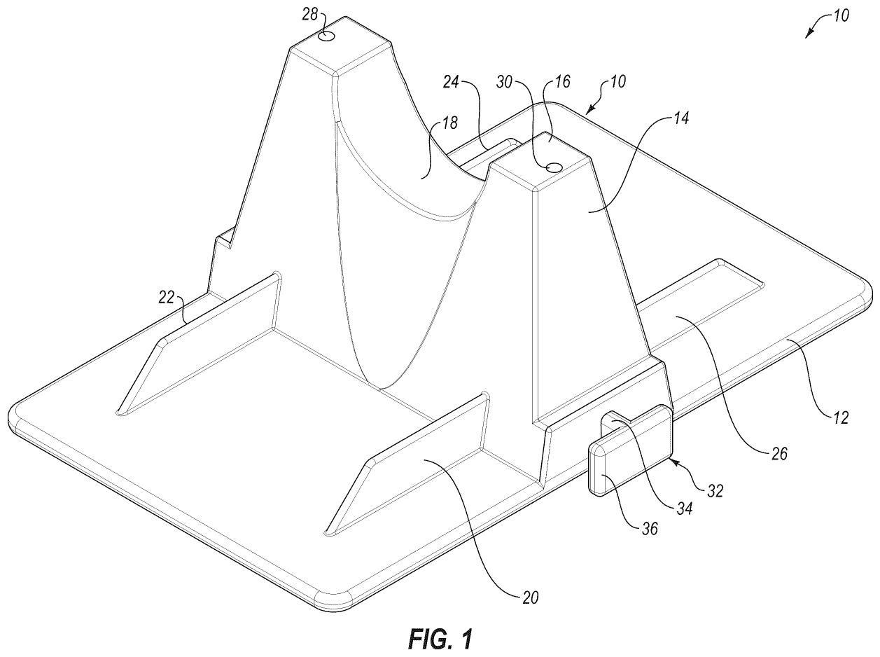

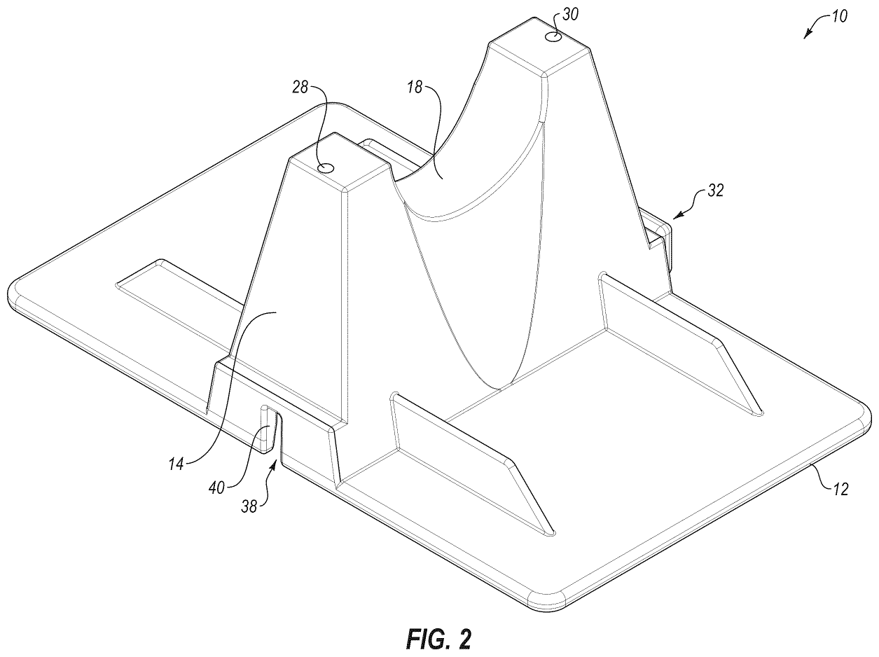

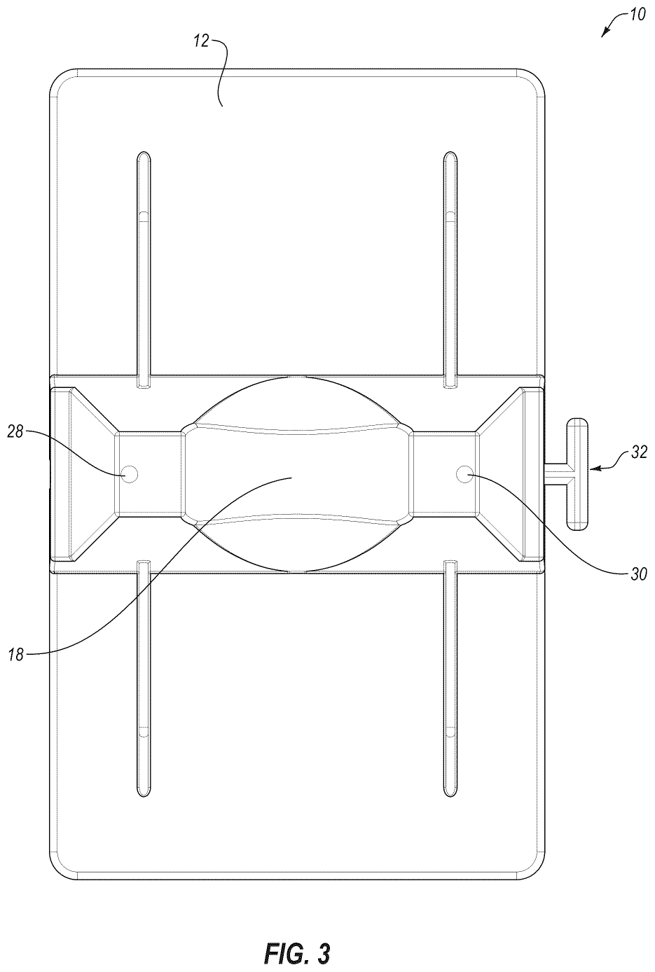

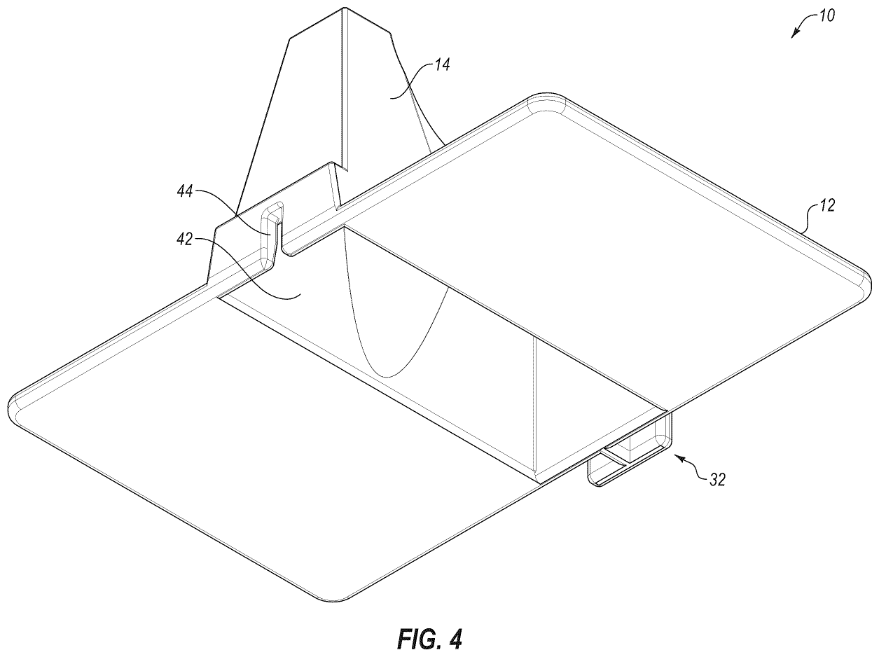

With general reference to FIGS. 1-4 for example, there is illustrated one embodiment of a support device 10. The support device 10 includes a base member 12 having a polygonal shape which in the illustrated form is a rectangle. However, other shapes and configurations for the base member 12 are possible and contemplated. The support device 10 further includes a support member 14 extending from the base member 12 to a proximal end 16 which includes a support receptacle 18. A plurality of weight distributing struts 20, 22, 24, and 26 extend between the support member 14 and the base member 12 in an arrangement configured to distribute weight from the support member 14 to the base member 12.

In the illustrated form, the support receptacle 18 is defined by a concave surface extending from the proximal end 16 of the support member 14 toward the base member 12. In this configuration for example, the support receptacle 18 may be configured to receive a pipe, conduit or similar component having an externally rounded configuration. However, variations in the form and configuration of the support receptacle 18 are possible and contemplated. For example, in some non-illustrated forms, the support receptacle 18 may include an open square or rectangular configuration, or the support receptacle 18 could include a closed configuration regardless of shape.

The support device 10 further includes a first aperture 28 and a second aperture 30 positioned on the proximal end 16 of the support member 14. More specifically, the first aperture 28 is positioned on a first side of the support receptacle 18 and the second aperture 30 is positioned on a second, opposite side of the support receptacle 18. The first aperture 28 and the second aperture 30 may each be configured to receive a fastener which couples a closure member to the proximal end 16 of the support member 14 in an arrangement which can secure a component in the support receptacle 18. Additionally or alternatively, the first aperture 28 and the second aperture 30 may each be sized and configured to receive a portion of a stacking device as described herein below.

The support device 10 also includes a coupling member 32 which includes a stem portion 34. In the illustrated form, the stem portion 34 extends laterally from a portion of the base member 12 and the support member 14, although other variations are possible. For example, in one form, the stem portion 34 may be positioned above the base member 12 and extend from the support member 14. The coupling member 32 also includes a head portion 36 which is laterally spaced from the base member 12 and the support member 14 by the stem portion 34. The head portion 36 is enlarged relative to the stem portion 34 in at least one direction, although variations in this configuration are possible and contemplated.

A coupling receptacle 38 is positioned opposite of the coupling member 32. Generally speaking, the coupling receptacle 38 is structured to receive a component corresponding in structure to the coupling member 32. That is, the coupling receptacle 38 of a first support device 10 is configured to receive the coupling member 32 of a second support device 10, although it is contemplated the configuration of the coupling receptacle 38 may be suitable for receiving other components. In the illustrated form for example, the coupling receptacle 38 includes a first portion 40 configured complementary to the configuration of the stem portion 34 and a second portion 42 configured complementary to the configuration of the head portion 36. For example, in the illustrated form the second portion 42 of the coupling receptacle 38 is enlarged relative to the first portion 40 of the coupling receptacle 38 similar to the head portion 36 being enlarged relative to the stem portion 34. More specifically, the first portion 40 of the coupling receptacle 38 is defined by a notch 44 formed in a portion of the base member 12 and the support member 14 and the second portion 42 of the coupling receptacle 38 is positioned in a hollow interior of the support member 14.

In this configuration, the coupling receptacle 38 is configured such that the notch 44 of a first support device 10 may be positioned over the stem portion 34 of the coupling member 32 of a second support device 10 and the head portion 36 of the coupling member 32 of the second support device 10 may be positioned in the second portion 42 of the coupling receptacle 38 of the first support device 10. When the first support device 10 and the second support device 10 are positioned in this manner, the cooperation of the coupling receptacle 38 of the first support device 10 and the coupling member 32 of the second support device 10 provide an arrangement where the first support device 10 and the second support device 10 are coupled to one another. In this arrangement for example, lateral separation of the first support device 10 from the second support device 10 may be prevented unless the first support device 10 is elevated relative to the second support device 10. It is contemplated that any number of the support devices 10 may be coupled in this manner.

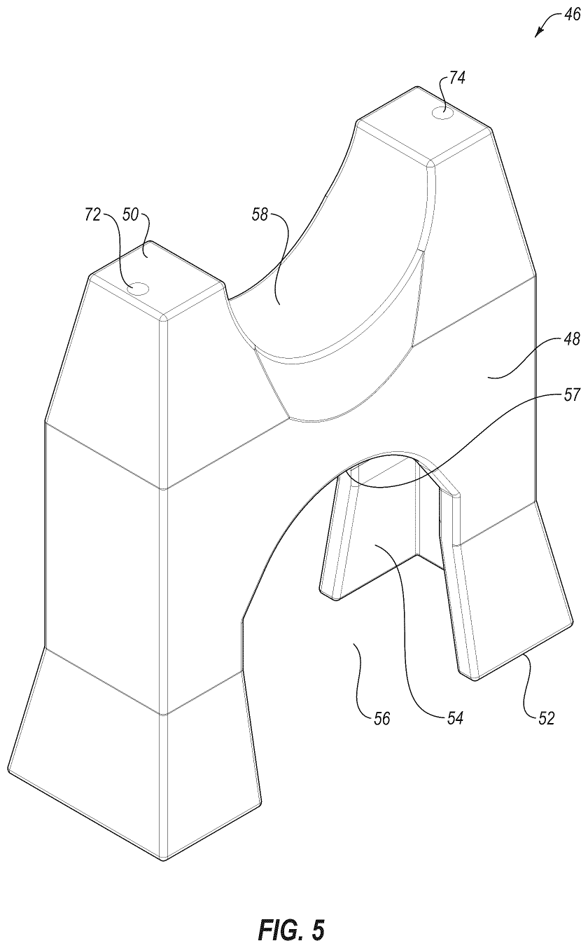

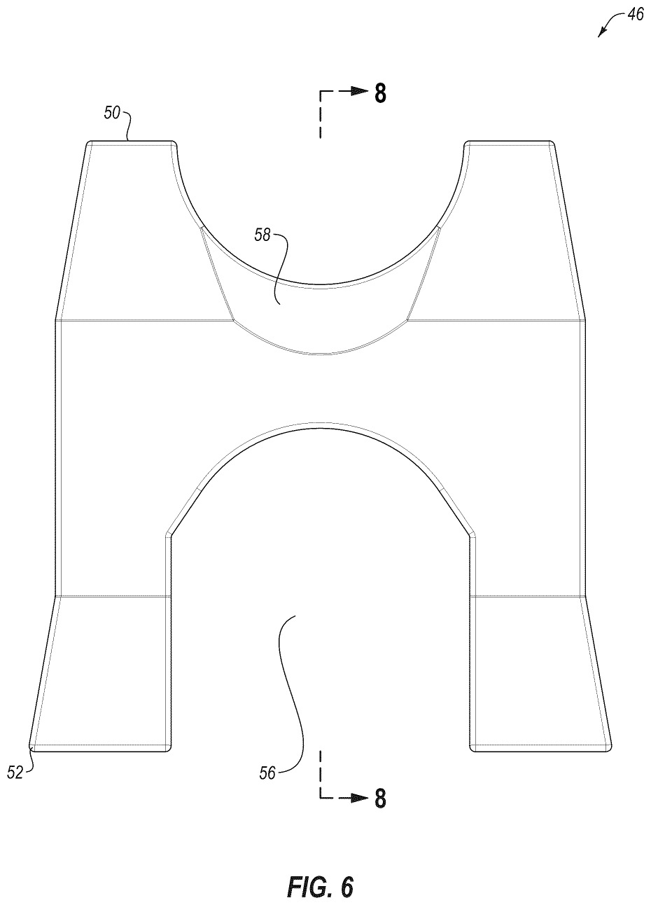

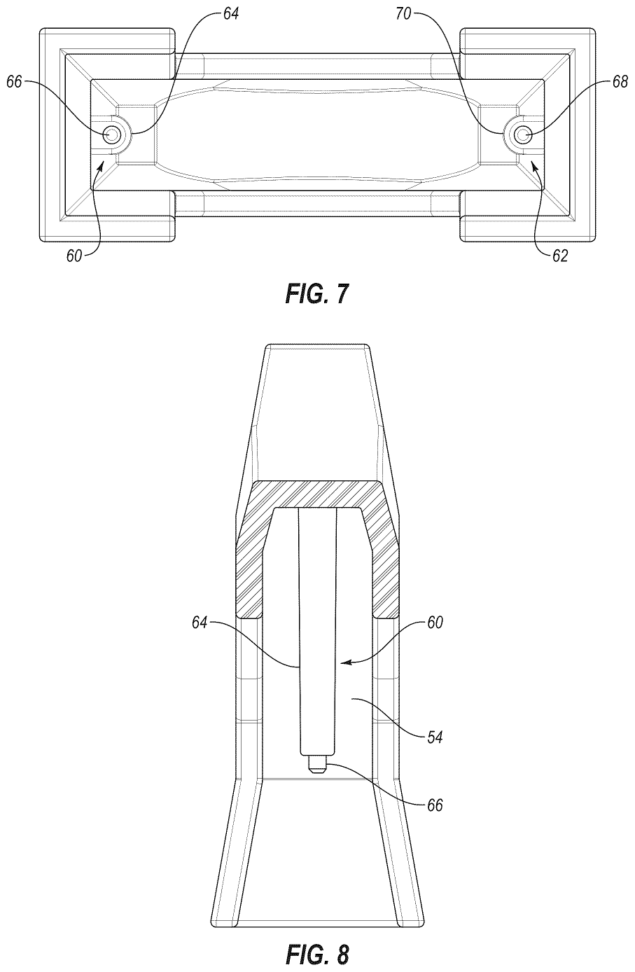

Referring now generally to FIGS. 5-8, there is illustrated a stacking device 46 which may be engaged with a support device 10 and/or other stacking devices 46. The stacking device 46 includes a body 48 extending between a proximal end 50 and a distal end 52. The body 48 generally includes a hollow interior 54 and a central opening 56 extending from and through the distal end 52 toward the proximal end 50. In the illustrated form, a proximal end 50 of the central opening 56 is defined by a proximally extending concave surface 57 of the body 48.

The stacking device 46 also includes a support surface 58 defined by the proximal end 50 of the body 48 and positioned opposite of and spaced apart from the central opening 56. In the illustrated form, the support surface 58 is defined by a concave surface extending distally from the proximal end 50 of the body 48 toward the distal end 52. In this configuration for example, the support surface 58 may be configured to receive a pipe, conduit or similar component having an externally rounded configuration. However, variations in the form and configuration of the support surface 58 are possible and contemplated. For example, in some non-illustrated forms, the support surface 58 may include an open square or rectangular configuration, or it could enclosed a closed configuration regardless of the shape thereof.

In the illustrated form, the stacking device 46 also includes a first guide member 60 and a second guide member 62 which are positioned in the hollow interior 54 and extend distally toward the distal end 52 of the body 48. The first guide member 60 includes a proximal portion 64 and a distal portion 66 having a reduced size relative to the proximal portion 64, and the second guide member 62 includes a proximal portion 68 and a distal portion 70 having a reduced size relative to the proximal portion 68.

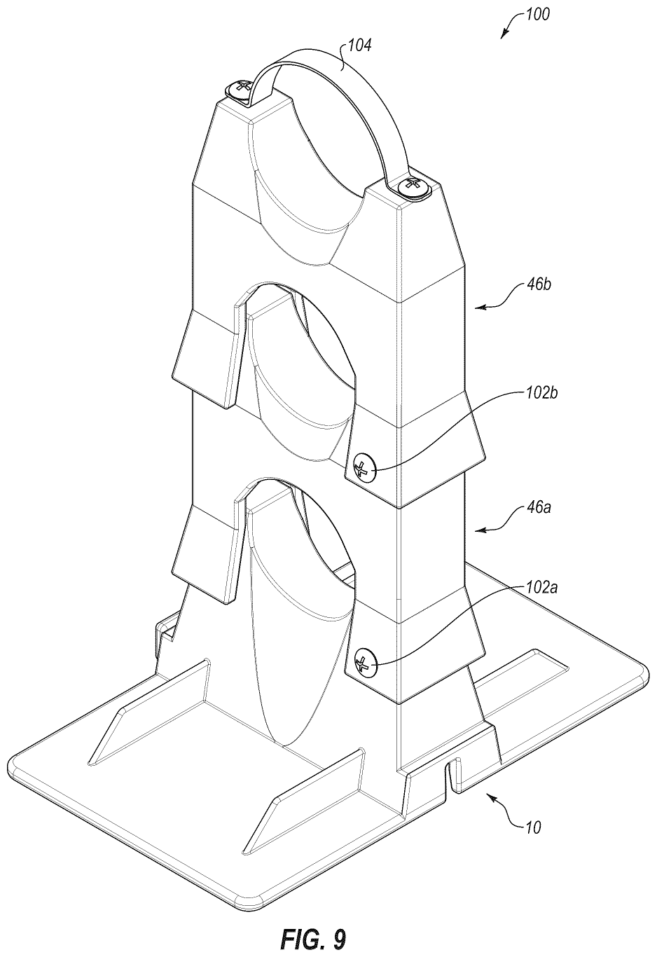

The proximal end 50 of the body 48 includes a first aperture 72 positioned on a first side of the support surface 58 and a second aperture 74 positioned on a second, opposite side of the support surface 58. The first aperture 72 and the second aperture 74 may each be configured to receive a fastener which couples a closure member to the proximal end 50 of the body 48 in an arrangement which can secure a component to the stacking device 46. Additionally or alternatively, the first aperture 72 and the second aperture 74 may be sized the same or substantially similar to the size of the distal portions 66, 70 of the guide members 60, 62, respectively. In this configuration, a portion of a first stacking device 46 may be positioned in the hollow interior 54 of a second stacking device 46 in an arrangement where the distal portions 66, 70 of the guide members 60, 62, respectively, of the second stacking device 46 are positioned in the first aperture 72 and the second aperture 74 of the first stacking device 46. When positioned in this manner, the first stacking device 46 and the second stacking device 46 cooperate to provide an enclosed area at least partially bound by the support surface 58 of the first stacking device 46 and the concave surface 57 of the body 48 of the second stacking device 46. In addition, the cooperation between guide members 60, 62 of the second stacking device 46 with the apertures 72, 74 of the first stacking device 46 may prevent lateral displacement between the stacking devices 46 as well as a press fit engagement which prevents or resists removal of the first stacking device 46 from the second stacking device 46. Additionally or alternatively, a fastener may be used to secure coupling of the stacking devices 46 together (e.g., shown in FIG. 9). It is contemplated that any number of the stacking devices 46 may be coupled in this manner.

In addition to the foregoing, a portion of a support device 10 may be positioned in the hollow interior 54 of a stacking device 46 in an arrangement where the distal portions 66, 70 of the guide members 60, 62, respectively, of the stacking device 46 are positioned in the apertures 28, 30 of the support device 10. When positioned in this manner, the support device 10 and the stacking device 46 cooperate to provide an enclosed area at least partially bound by the support receptacle 18 of the support device 10 and the concave surface 57 of the body 48 of the stacking device 46. In addition, the cooperation between guide members 60, 62 of the stacking device 46 with the apertures 28, 30 of the support device 10 may prevent lateral displacement of the stacking device 46 from the support device 10 as well as a press fit engagement which prevents or resists removal of the stacking device 46 from the support device 10. Additionally or alternatively, a fastener may be used to secure coupling of the support device 10 and the stacking device 46 together (e.g., as shown in FIG. 9).

Referring now to FIG. 9, there is illustrated a system 100 which includes a plurality of stacking devices 46a, 46b and a support device 10. The support device 10 is coupled with the stacking device 46a in the manner described above, and a fastener 102a is used to secure coupling of the support device 10 and the stacking device 46a. Further, the stacking device 46a is coupled with the stacking device 46b in the manner described above, and a fastener 102b is used to secure coupling of the stacking device 46a and the stacking device 46b. A closure member 104 is coupled to the stacking device 46b and may be used to secure a component to the stacking device 46b. It is contemplated that any number of stacking devices 46 and/or support devices 10 could be used in the system 100.

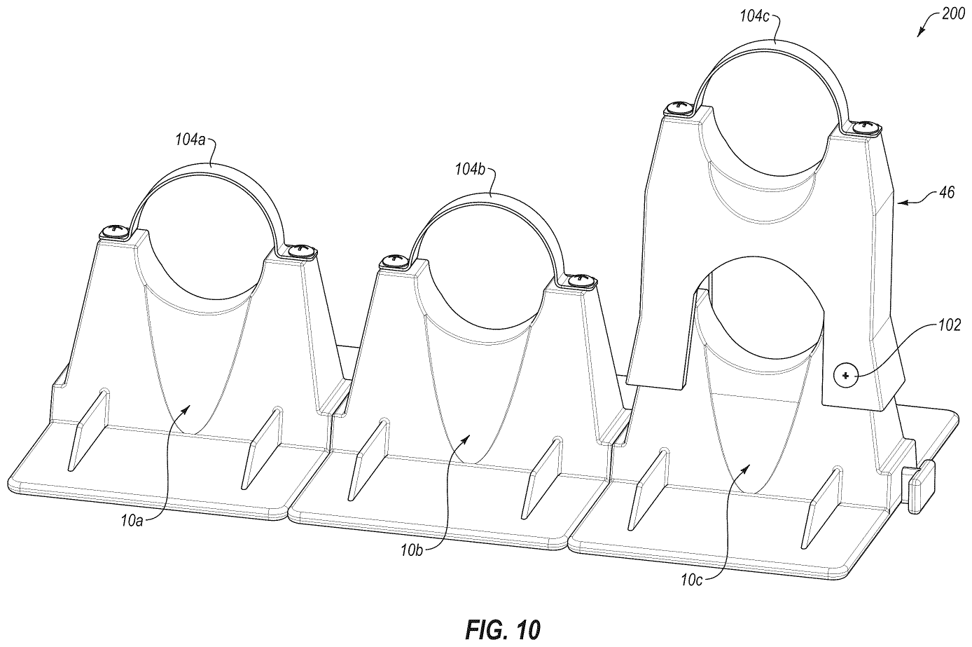

An alternative system 200 is illustrated in FIG. 10. The system 200 incudes a plurality of support devices 10a, 10b and 10c, and a stacking device 46. The support device 10a is coupled to the support device 10b in the manner described above, and the support device 10b is coupled to the support device 10c in the manner described above. Further, the stacking device 46 is coupled to the support device 10c in the manner described above, and a fastener 102 is used to secure coupling of the stacking device 46 and the support device 10. A closure member 104a is coupled to the support device 10a and may be used to secure a component to the support device 10a, a closure member 104b is coupled to the support device 10b and may be used to secure a component to the support device 10b, and a closure member 104c is coupled to the stacking device 46 and may be used to secure a component to the stacking device 46. It is contemplated that any number of stacking devices 46 and/or support devices 10 could be used in the system 200.

The devices described herein may be used in connection with providing support and/or securing positioning of a number of different objects. A few non-limiting examples of different objects which may be supported by the devices described herein include HVAC ductwork, refrigeration lines, electric conduit, plumbing lines and/or modular walkways. In addition, the devices described herein may be made from a variety of different materials. In some aspects, the support members may be made from a polymer or plastic material. However, other variations are possible and contemplated.

In one embodiment, a support device, comprising includes a base member, a support member extending from the base member to a proximal end including a support receptacle; a coupling member including a stem portion and a head portion laterally spaced from the base member and the support member by the stem portion, and a coupling receptacle positioned opposite of the coupling member. The coupling receptacle being structured to receive a component corresponding in structure to the coupling member.

In one form, the head portion is enlarged relative to the stem portion.

In one aspect of this form, the coupling receptacle includes a first portion and a second portion, the second portion being enlarged relative to the first portion.

In another form, the device further includes a first aperture and a second aperture positioned on the proximal end of the support member.

In one aspect of this form, the first aperture and the second aperture are positioned on opposites sides of the support receptacle.

In another form, the support receptacle is defined by a concave surface extending from the proximal end of the support member toward the base member.

In still another form, the coupling receptacle includes a first portion defined by a notch formed in a portion of the base member and the support member.

In one aspect of this form, the coupling receptacle includes a second portion positioned in a hollow interior of the support member.

In another form, the device further includes a plurality of weight distributing struts extending between the support member and the base member.

In another embodiment, a stacking device includes a body extending between a proximal end and a distal end. The body includes a hollow interior and a central opening extending from and through the distal end toward the proximal end. The stacking device also includes a support surface defined by the proximal end of the body and positioned opposite of and spaced apart from the central opening, and a number of guide members positioned in the hollow interior and extending distally toward the distal end of the body. Each of the guide members includes a proximal portion and a distal portion having a reduced size relative to the proximal portion.

In one form, the proximal end of the body includes a first aperture positioned on a first side of the support surface and a second aperture positioned on a second, opposite side of the support surface.

In one aspect, the first and second apertures are sized the same or substantially similar to the size of the distal portion of the guide members.

In another aspect, the support surface is defined by a distally extending concave surface formed in the proximal end of the body.

In still another aspect, a proximal end of the central opening is defined by a proximally extending concave surface of the body.

In another embodiment, a system includes a plurality of stacking devices described herein where the proximal end of a first stacking device is positionable in the hollow interior of a second stacking device in an arrangement where the distal end of each of the guide members of the second stacking device is positioned in a respective one of a first aperture and a second aperture of the first stacking device.

In yet another embodiment, a system includes a plurality of support devices as described herein where the coupling member of a first support device is positionable in the coupling receptacle of a second support device in an arrangement preventing lateral separation of the first support device and the second support device.

In one form, the system further includes a stacking device as described herein positionable on the first support device in an arrangement where the distal end of each of the guide members of the stacking device is positioned in a respective one of a first aperture and a second aperture of the first support device.

In one aspect, the system further includes a fastener configured to secure coupling of the first support device and the stacking device.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A support device, comprising:
a base member;
a support member extending from the base member to a proximal end including a support receptacle;
a coupling member including a stem portion and a head portion laterally spaced from the base member and the support member by the stem portion; and
a coupling receptacle positioned opposite of the coupling member, the coupling receptacle being structured to receive a component corresponding in structure to the coupling member.

2. The support device of claim 1, wherein the head portion is enlarged relative to the stem portion.

3. The support device of claim 2, wherein the coupling receptacle includes a first portion and a second portion, the second portion being enlarged relative to the first portion.

4. The support device of claim 1, further comprising a first aperture and a second aperture positioned on the proximal end of the support member.

5. The support device of claim 4, wherein the first aperture and the second aperture are positioned on opposites sides of the support receptacle.

6. The support device of claim 1, wherein the support receptacle is defined by a concave surface extending from the proximal end of the support member toward the base member.

7. The support device of claim 1, wherein the coupling receptacle includes a first portion defined by a notch formed in a portion of the base member and the support member.

8. The support device of claim 7, wherein the coupling receptacle includes a second portion positioned in a hollow interior of the support member.

9. The support device of claim 1, further comprising a plurality of weight distributing struts extending between the support member and the base member.

10. A stacking device, comprising:
a body extending between a proximal end and a distal end, the body including a hollow interior and a central opening extending from and through the distal end toward the proximal end;
a support surface defined by the proximal end of the body and positioned opposite of and spaced apart from the central opening; and
a number of guide members positioned in the hollow interior and extending distally toward the distal end of the body, wherein each of the guide members includes a proximal portion and a distal portion having a reduced size relative to the proximal portion.

11. The stacking device of claim 10, wherein the proximal end of the body includes a first aperture positioned on a first side of the support surface and a second aperture positioned on a second, opposite side of the support surface.

12. The stacking device of claim 11, wherein the first and second apertures are sized the same or substantially similar to the size of the distal portion of the guide members.

13. The stacking device of claim 11, wherein the support surface is defined by a distally extending concave surface formed in the proximal end of the body.

14. The stacking device of claim 13, wherein a proximal end of the central opening is defined by a proximally extending concave surface of the body.

15. A system, comprising a plurality of stacking devices according to claim 10, wherein the proximal end of a first stacking device is positionable in the hollow interior of a second stacking device in an arrangement where the distal end of each of the guide members of the second stacking device is positioned in a respective one of a first aperture and a second aperture of the first stacking device.

16. A system, comprising a plurality of support devices according to claim 1, wherein the coupling member of a first support device is positionable in the coupling receptacle of a second support device in an arrangement preventing lateral separation of the first support device and the second support device.

17. The system of claim 16, further comprising a stacking device according to claim 10 positionable on the first support device in an arrangement where the distal end of each of the guide members of the stacking device is positioned in a respective one of a first aperture and a second aperture of the first support device.

18. The device of claim 17, further comprising a fastener configured to secure coupling of the first support device and the stacking device.
